(19) United States
(12) Patent Application Publication
(10) Pub. No.: US 2013/0301183 A1
(43) Pub. Date: Nov. 14, 2013

(54) CAPACITIVE TOUCH DEVICE

(71) Applicant: SONGTAK TECHNOLOGY CO., LTD., Taoyuan City (TW)

(72) Inventor: MAO-SUNG WU, TAOYUAN CITY (TW)

(21) Appl. No.: 13/942,968

(22) Filed: Jul. 16, 2013

Related U.S. Application Data
(63) Continuation of application No. 13/157,389, filed on Jun. 10, 2011.

(51) Int. Cl. H01G 5/01

(52) U.S. Cl. CPC H01G 5/01
USPC 361/283.4

(57) ABSTRACT

A capacitive touch device includes a transparent handheld portion and a touch portion, and the transparent handheld portion has at least one sensing structure, and the touch portion is disposed at an end of the transparent handheld portion and has a flexible conductive element, and a user can hold the handheld portion. When the flexible conductive element is contacted with the capacitive touch panel, a capacitive coupling is formed to produce current, to achieve the touch operation effect.

### BACKGROUND OF THE INVENTION

1. Field of the Invention

The present invention relates to a capacitive touch device, and more particularly to a capacitive touch device capable of conducting current to the human body by a touch device to achieve the touch operation effect.

2. Brief Description of the Related Art

At present, touch technologies are used extensively in various kinds of electronic products, and resistive touch panels adopt a pressing method to contact upper and lower conductive films to control and operate the resistive touch panels. For capacitive touch panels, a user's finger gently touches the capacitive touch panel, such that a capacitance change is produced between the user's finger and the capacitive touch panel to control and operate the capacitive touch panel. In other words, the capacitive touch panels have a higher sensitivity and advantage on the control and operation than the resistive touch panel.

Compared with the general resistive touch panels, the capacitive touch panels have the anti-dust, anti-fire, anti-scratch, high resolution, high penetrability, low reflection, high contrast, and durable effects and also support multi-point touch and gesture operation, and thus the capacitive touch panels become a target for manufacturers to develop.

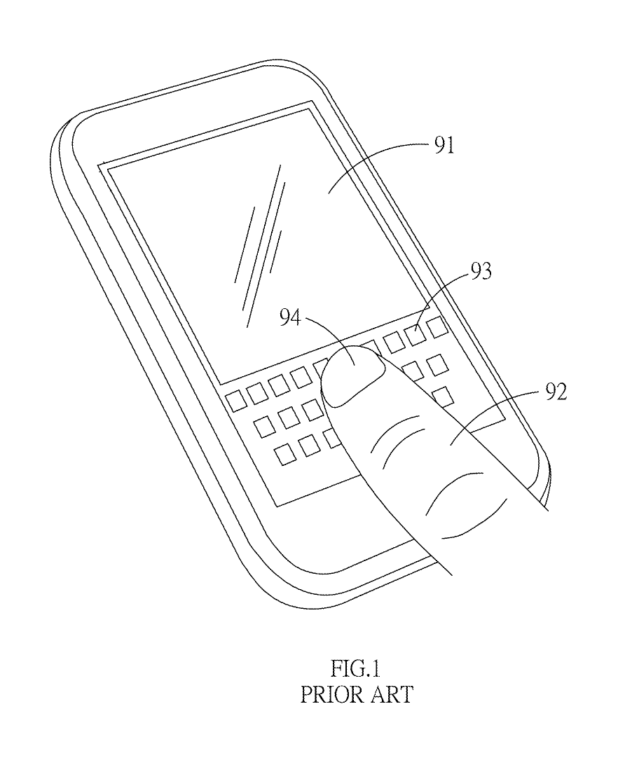

With reference to FIG. 1, a user is using a capacitive touch panel 91 and operates a virtual keyboard 93 of the capacitive touch panel 91 by a pulp control of a finger 92. During the operation, the finger 92 blocks a portion of the user's vision, and the large pulp area of the finger 92 causes an expected touch and error, and this case become more serious when the user has a bigger finger.

Since the nail 94 of the finger 92 is not a conductor, therefore the nail 94 cannot produce an appropriate capacitance with the capacitive touch panel 91. When the user touches the capacitive touch panel 91, the user with a long nail has difficulties to operate the capacitive touch panel 91.

In general, the finger may be stained easily, particularly with sweat in hot weather, and the sweat of the hand also causes a problem to the touch operation. When the finger 92 with sweat touches the capacitive touch panel 91, the sweat or stain will remain on the capacitive touch panel 91 and make it difficult to user to maintain a clean capacitive touch panel 91.

Therefore, present technologies for controlling the capacitive touch panel 91 by the finger 92 still have many drawbacks. It is a subject for the present invention to keep the capacitive touch panel 91 clean all the time, and produce an appropriate capacitance effectively, and operate and control the capacitive touch panel 91 accurately and quickly. It follows that developing a structure that can be applied to various touch panels and be attached with the touch panel closely to prevent damage to the touch panel by pressing demands immediate attention and feasible solutions.

### SUMMARY OF THE INVENTION

In view of the aforementioned drawbacks, it is a primary objective of the present invention to provide a capacitive touch device capable of conducting current to a human body by a touch device to achieve the desired touch operation effect.

To achieve the foregoing objective, the present invention provides a capacitive touch device comprising: a transparent handheld portion, provided for a user to hold, and the transparent handheld portion having at least one sensing structure; and a touch portion, disposed at an end of the transparent handheld portion, and the touch portion having a flexible conductive element for contacting with a capacitive panel. Users can hold the handheld portion, such that when the flexible conductive element is contacted with the capacitive touch panel, a capacitive coupling is formed to generate current to achieve the touch operation effect.

### BRIEF DESCRIPTION OF THE INVENTION

FIG. 1 is a schematic view of using a conventional touch panel;

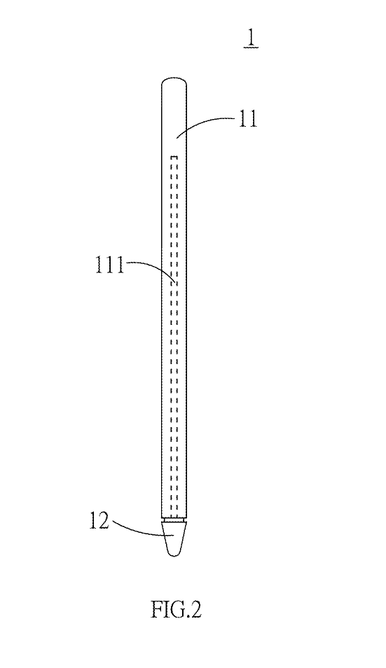

FIG. 2 is a schematic view of a capacitive touch device in accordance with a first preferred embodiment of the present invention;

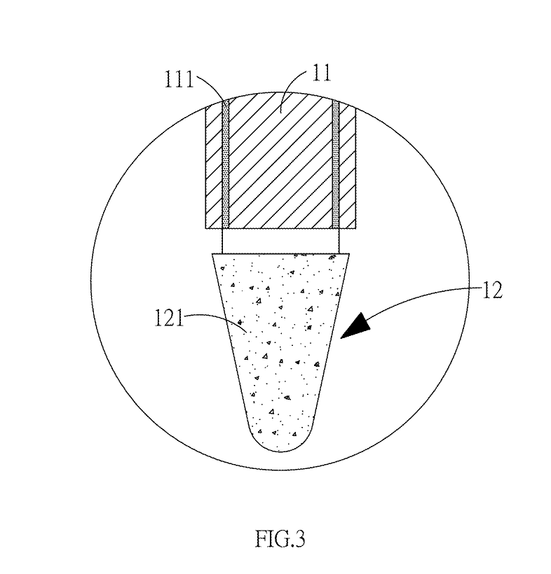

FIG. 3 is an enlarged view of a capacitive touch device in accordance with a first preferred embodiment of the present invention;

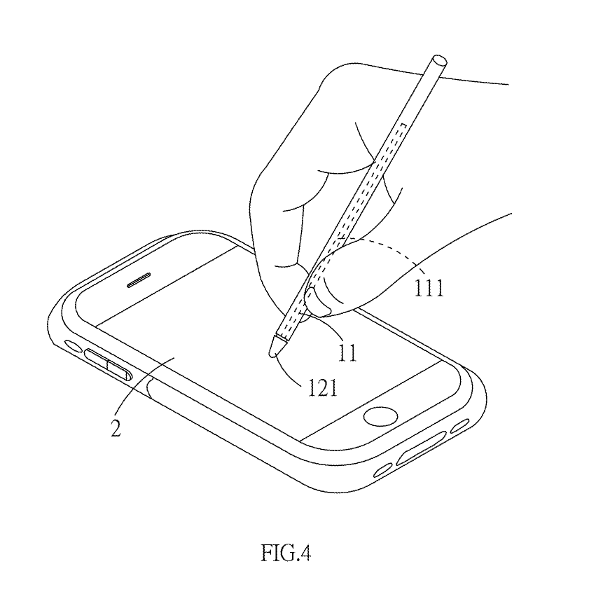

FIG. 4 is a schematic view of using a capacitive touch device in accordance with a first preferred embodiment of the present invention;

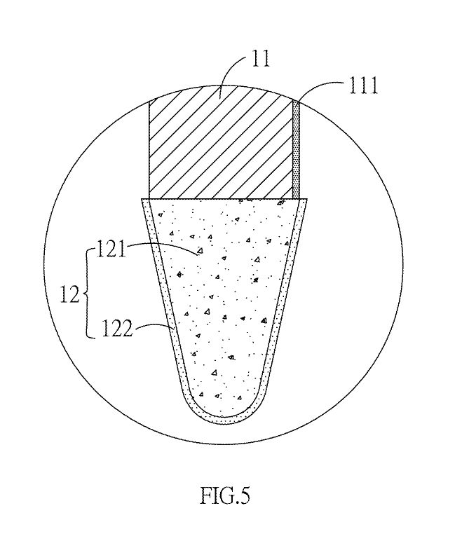

FIG. 5 is an enlarged view of a capacitive touch device in accordance with a second preferred embodiment of the present invention; and

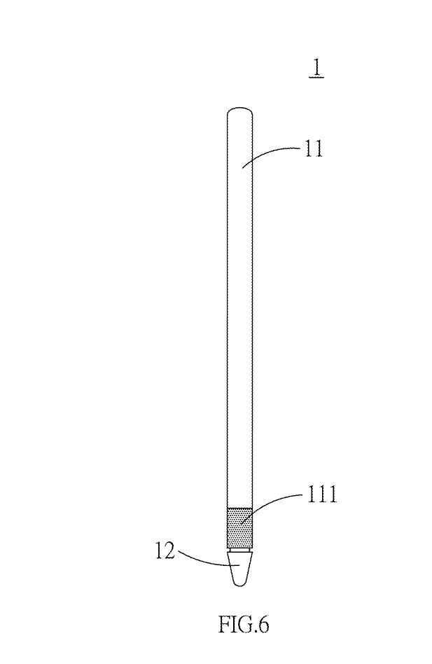

FIG. 6 is a schematic view of a capacitive touch device in accordance with a third preferred embodiment of the present invention.

### DETAILED DESCRIPTION OF THE PREFERRED EMBODIMENTS

The above and further objects and novel features of the invention will more fully appear from the following detailed description in connection with the accompanying drawings.

With reference to FIGS. 2 and 3 for the basic structure of a capacitive touch device in accordance with the present invention, the capacitive touch device 1 comprises a transparent handheld portion 11 and a touch portion 12.

The transparent handheld portion 11 is provided for a user to hold, and the transparent handheld portion 11 has at least one sensing structure 111. In this embodiment, the sensing structure 111 is a metal conductive layer and the sensing structure 111 is disposed in the transparent handheld portion 11.

The touch portion 12 is disposed at an end of the transparent handheld portion 11, and the touch portion 12 has a flexible conductive element 121, wherein the flexible conductive element 121 is made of conductive rubber, conductive plastic or conductive foam and provided for contacting with a capacitive panel.

When in use, a user holds the handheld portion 11 of the touch device by a hand to touch the capacitive panel 2. In FIG. 4, the user's body is contacted with the sensing structure 111b through the hand and the flexible conductive element 121 at an end is contacted with the capacitive panel 2 to form a conductive loop, such that a capacitive coupling can be produced with the electric field of the conductive layer on the external side of the capacitive panel 2, and then the user's body absorbs a small current, such that the electrodes can detect a current, so as to achieve the touch operation.

In addition, the sensing structure 111 can be covered onto the external surface of the transparent handheld portion 11 as shown in FIG. 5, and contacted with the flexible conductive element 121. Further, the flexible conductive element 121 can have a coating layer 122 formed thereon for providing a better smoothness to allow the user to slide and touch a touch panel without damaging the touch panel, wherein the coating layer 122 can be coated onto the flexible conductive element 121 through carbon or copper powder, or the coating layer 122 can be made of polyurethane (PU).

The sensing structure 111 can be installed between the transparent handheld portion 11 and the touch portion 12 as shown in FIG. 6, and contacted with the flexible conductive element 121 or not contacted with the flexible conductive element.

In summation of the description above, the present invention provides a feasible capacitive touch device to improve over the prior art and complies with the patent application requirements, and is thus duly filed for a patent application. While the invention has been described by means of specific embodiments, numerous modifications and variations could be made thereto by those skilled in the art without departing from the scope and spirit of the invention set forth in the claims.

What is claimed is:

1. A capacitive touch device, comprising:
a transparent elongated handheld portion for grasping by a user, the handheld portion extending in a longitudinal direction and having two ends and provided with at least one sensing structure extending along the longitudinal direction; and
a conical-shaped, pliable conductive portion for contact with a capacitive panel, extending from one of the two ends of the transparent handheld portion in the longitudinal direction.

2. The capacitive touch device of claim 1, wherein the sensing structure is a metal conductive layer.

3. The capacitive touch device of claim 1, wherein the sensing structure is installed in the transparent handheld portion.

4. The capacitive touch device of claim 3, wherein the sensing structure is contacted with the flexible conductive element.

5. The capacitive touch device of claim 1, wherein the sensing structure is covered onto an external surface of the transparent handheld portion.

6. The capacitive touch device of claim 5, wherein the sensing structure is contacted with the flexible conductive element.

7. The capacitive touch device of claim 1, wherein the flexible conductive element includes a coating layer coated thereon.

8. The capacitive touch device of claim 1, wherein the flexible conductive element is one selected from the collection of conductive rubber, conductive plastic and conductive foam.

9. The capacitive touch device of claim 1, wherein the coating layer is coated onto the exterior of the flexible conductive element through carbon powder.

10. The capacitive touch device of claim 1, wherein the coating layer is coated onto the exterior of the flexible conductive element through copper powder.

11. The capacitive touch device of claim 1, wherein the coating layer is made of polyurethane (PU).

12. The capacitive touch device of claim 1, wherein the sensing structure is installed between the transparent handheld portion and the touch portion.

13. The capacitive touch device of claim 12, wherein the sensing structure is contacted with the flexible conductive element.
